(19) United States
(12) Patent Application Publication
(10) Pub. No.: US 2013/0193287 A1
(43) Pub. Date: Aug. 1, 2013

(54) GARDEN HANGING APPARATUS AND METHOD

(71) Applicant: Daniel J. Murphy, Hurst, TX (US)

(72) Inventor: Daniel J. Murphy, Hurst, TX (US)

(21) Appl. No.: 13/750,356

(22) Filed: Jan. 25, 2013

Related U.S. Application Data
(60) Provisional application No. 61/592,345, filed on Jan. 30, 2012.

(51) Int. Cl. F16M 13/02

(52) U.S. Cl. CPC F16M 13/02
USPC 248/219.1; 248/219.4

(57) ABSTRACT

The garden hanging apparatus comprises a bracket, a hook member, and one or more clamping members. The bracket comprises a extending member, and a brace member. In other embodiments, the bracket further comprises a vertical member. In such embodiments, the brace member spans between and is coupled to the extending and vertical members. A method of positioning an object adjacent to a fence post, is provided, the method comprising the steps of providing a fence post; providing an apparatus comprising one or more arcuate tension members and an extension member, the one or more tension members being directly or indirectly coupled to the extension member; pressing the apparatus against a longitudinal side of the post such that the post is positioned within a space defined by first and second ends of the one or more tension members; and positioning the object on the extension member.

### FIELD OF THE INVENTION

The present invention relates generally to hanging devices and specifically to a garden hanging device that attaches easily to cylindrical metal fence posts without the need of tools and a method regarding same.

### BACKGROUND OF THE INVENTION

Within the residential setting, many homeowners and renters have privacy fences around the perimeter of their yards. While important for privacy, such fences can often be an eyesore. The aesthetic appearance of a privacy fence is often improved by placing landscaping, fountains, and other ornamental fixtures near the fence. However, most landscaping features are semi-permanent in nature and, thus, not easily changed or replaced. Because of this limitation, home occupiers often choose to place more temporary displays in their yards. Such temporary displays often take the form of potted plants, hanging baskets, bird baths, bird feeders, and the like. With respect to those displays suitable for hanging, it is often desirable to place such displays on the perimeter fencing. There are several conventional and commercially available products that permit a gardener to place a bracket or shelf on a perimeter fence having wooden fence posts. For example, some commercially available hangers are designed to be secured to wooden post with nails or screws. However, many city ordinances now require the use of metal fence posts for perimeter stockade fencing.

With the use of metal fence posts, there is a need for a garden hanging device that can be easily attached to such posts without the need for tools.

The garden hanging apparatus of the present invention is structured and arranged to be readily applied directly to the fence post through the use of tension or spring flex type clamps and fasteners. In a preferred embodiment, the device comprises a bracket, a hook member, one or more clamp extension arms, and one or more clamping members. The bracket is generally right triangular in shape and comprises an extending member, and a brace member. In other embodiments, the bracket further comprises a vertical member. In such embodiments, the brace member spans between and is coupled to the extending and vertical members. In the preferred embodiment, the extending member is generally oriented above the brace member and comprises a hook member positioned near an intersection of the brace and extending members.

The apparatus is structured and arranged such that it can easily be mounted to a fence post, and when so mounted, is capable of supporting an object suspended from the hook or other portion of the bracket or an object positioned on top of or within the bracket. The bracket is coupled to the post by one or more of the clamping members. In preferred embodiments, these clamping members may comprise a C-shaped spring/flexible tension assembly, a C-shaped clamp/clasp assembly, a U-shaped clamp/clasp assembly, or a U-shaped spring/flexible tension assembly.

In another embodiment of the invention, the garden hanging apparatus can be attached to a larger diameter fence post such as light posts and awning posts in front of buildings.

In another embodiment, the apparatus may be coupled to a vertical post. In another embodiment, the apparatus may be coupled to a horizontal post.

In another embodiment of the invention, the garden hanging apparatus may comprise ornate features.

Additionally, the hanging device is readily adaptable for use outside the garden within towns, communities, etc. near streets and walkways on poles and posts to display flags and banners.

### DESCRIPTION OF THE PRIOR ART

A number of patents and patent publications teach hanging devices. For example, U.S. Pat. No. 6,708,832 issued to Hannon teaches a device for hanging objects on a vertical support. U.S. Pat. No. 3,746,294 issued to Johnston teaches a lantern hanger assembly. U.S. Pat. No. 4,744,537 issued to Buckley, teaches a hanger bracket. U.S. Pat. No. 5,337,986 issued to Vollink teaches a hanging-plant support assembly. U.S. Pat. No. 6,202,964 issued to Thornhill teaches a multi-purpose hanger. Pribanich, U.S. Design Pat. No. 632,517, illustrates an ornamental design for a plant and birdfeeder hanger. Holland, U.S. Design Pat. 461,429, illustrates an ornamental design for a hanging plant brace. Hollinger, U.S. Design Pat. 348,631, illustrates an ornamental design for a plant bracket.

However, there remains a need for a fence post hanger that is secure, easily mountable without tools, and which may be coupled to a variety of fence posts for use with a variety of objects.

### SUMMARY OF THE INVENTION

The present disclosure provides a fence post hanger that is secure, easily mountable without tools, and which may be coupled to a variety of fence posts for use with a variety of objects, and a method regarding same. The device comprises one or more clamp extending members, and one or more clamping (tension) members. In certain embodiments, the extending member may be an element of a bracket. The bracket is generally right-triangular in shape and comprises an extending member, and a brace member. In other embodiments, the bracket further comprises a vertical member. In such embodiments, the brace member spans between and is coupled to the extending and vertical members. In the preferred embodiment, the extending member is generally oriented above the brace member and comprises a hook member positioned near an intersection of the brace and extending members. Such hook member is suitable for suspending or hanging an object such as a hanging basket.

The apparatus is structured and arranged such that it can easily be mounted to a horizontal or vertical fence post, and when so mounted, is capable of supporting an object suspended from the hook or other portion of the bracket or an object positioned on top of or within the bracket. The extending member and/or the support member may be directly coupled to the post or indirectly by the vertical member by one or more of the clamping (tension) members In preferred embodiments, these clamping members may comprise a C-shaped spring/flexible tension assembly, a C or U-shaped clamp/clasp assembly, or a U-shaped spring/flexible tension assembly, or some other suitable arrangement. In one embodiment, the apparatus is secured to the post with two clamping members In this embodiment, a clamp extension arm spans between an upper clamping member and the extending member such that the upper clamping member is positioned approximately adjacent to the extending member at the top of the bracket. At a lower end of the bracket a lower clamping member is coupled to the bracket with a lower clamp extension arm such that the lower clamping member is positioned at a lower end of the brace member at the bottom of the bracket.

The clamping members of this embodiment each comprise a U-shaped spring/flexible tension assembly. This assembly comprises the extension arm and collars (sides) arranged such that the collars may be positioned around the post. The collars are structured such that the assembly is flexible and elastic. Collars have sufficient tension forces acting opposite of one another such that the assembly rests in an open position. The collars comprise padding such that the assembly will not abrade, scratch, or otherwise damage the post when placed in position. The collars may be closed about a post by use of latch mechanism so that the assembly and apparatus may be positioned on the post.

The latch mechanism of the certain embodiments comprises a main body and a detent portion which allow for cooperative coupling of the two portions. The main body comprises a lever pivotally coupled by pin to base. Pivotally coupled to the lever is clasp which is structured and arranged to be cooperatively coupled at clasp end within detent slot of the detent portion. Detent openings permit the detent to be mounted on collar. Main body base has base openings that permit the main body to be coupled to collar. Side plate pivots with lever provide support for lever when in a closed position. Lever has an opening that is arranged to allow locking portion to be inserted. Locking portion is pivotally and elastically coupled to side mount with pin. A front ridge of locking portion engages front portion of lever opening to allow the latch to be securely closed.

When in an open position, the latch is coupled to one collar. The latch is arranged so that it may be coupled to the other collar and drawn tight. Thus, the latch spans from one collar to the other when in a closed position. Drawing the collars tight when the assembly is in the closed position brings the two collars nearer to one another and snugly against the post. This latch is adjustable so that it can be easily used on posts of different diameters. For example, collar may comprise openings which allow detent to be positioned in different openings so as to allow the U-shaped clamping assembly to accommodate different sized posts. Thus, the latch mechanism permits the clamping member to be closed around the post so that the device may be easily attached to the post without the use of tools.

The upper clamping member is positioned beneath the metal fence post cap and the lower clamping member placed generally in-line with the upper clamping member and around the post in a lower position. With the clamping member placed in the secure closed position, the apparatus will generally not twist or slide and will remain in a desired position on the post.

In another embodiment, one or more of the clamping members comprise a C-shaped spring/flexible tension assembly which secures the device to the metal post of a stockade fence. In this embodiment, assembly comprises collars arranged so as to be in tension towards each other. The collars form an opening between them such that the assembly, when in a closed position, generally conforms to the contours of the post. The tension aspect of the assembly permits the collars to compress against the post when the assembly is positioned around the post. Tapered opening permits the assembly to be easily pressed onto a post. Such action expands collars to allow the post to enter opening. As the assembly is pressed further against post, collar ends move off the post allowing collars to contract towards one another and against the post. In this embodiment, the top clamping member is placed just under the fence post cap and immediately above the bracket that attaches the post to the stockade fence. The clamping members may also comprise U-shaped spring/flexible tension assembly.

In other embodiments, the garden hanging apparatus may comprise ornate features in an inner right-angle portion of the device. In this embodiment, the bracket is generally right triangular in shape and comprises a extending member, a brace member and a vertical member. The brace member spans between and is coupled to the extending and vertical members. The device further comprises a C, U, or otherwise arcuate shaped fastener assembly adapted to be positioned beneath the metal fence post cap and immediately above the fence bracket. In this embodiment the fastener assembly extends from the extending member such that it may be placed around the fence post. In this embodiment, the assembly comprises collars that form fastener opening. This opening has a diameter that permits the assembly to be placed around the post but narrow enough to prevent the assembly from sliding over the fence post cap. A U-shaped tension or flex clamp/clasp assembly may also be used to attach the apparatus to the metal fence post.

The bracket of this embodiment further comprises ornate features. Such features may comprise decorative material which may also provide additional structural support to the bracket. In one embodiment the apparatus with ornate features may comprise U-shaped, C-shaped, circular, or otherwise arcuate shaped clamps/clasps assemblies with easy lock spring or tension features to secure the device to the metal fence posts.

In another embodiment, the bracket may comprise a flag holder which may be used to display and secure flags, banners, and other objects comprising a shaft. In another embodiment, the bracket may comprise a shelf upon which objects may be supported. In still other embodiments, the apparatus may be combined with another apparatus with an object or shelf spanning between the two devices.

The apparatus may be secured to larger diameter metal posts. In such an embodiment, the garden hanging apparatus may be attached to the post by use of the cushioned and padded collar assembly. Such a collar assembly comprises a flexible latch portion that prevents abrasion of metal or wooden posts.

In one embodiment, the apparatus presents a wooden or rustic appearance.

In one embodiment, the apparatus comprises a collapsible bracket wherein the brace member or the extending member comprise a hinge arrangement.

In one embodiment, the apparatus comprises a cylindrical element adapted to hold an object such as the pot of a potted plant. In one embodiment, the cylindrical element is removably coupled to the bracket.

In one embodiment, the apparatus comprises an open portion adapted to receive a hook of a hanging object.

In one embodiment, the apparatus comprises a retractable element. In one embodiment, the retractable element is telescopically arranged. In one embodiment, the retractable element comprises an open portion adapted to receive a hook of a hanging object.

In one embodiment the bracket comprises a quick release element.

In one embodiment the bracket comprises clamping members adapted to receive one or more wing nuts.

In one embodiment the bracket is adapted to receive one or more wing nuts at a position in which a hanging object is secured.

In one embodiment the bracket comprises clamping members comprising rubber, silicone, or similar material.

In a preferred embodiment of the method, the method of positioning an object adjacent to a fence post, comprises the steps of providing a fence post; providing an apparatus comprising one or more arcuate tension members and an extension member, the one or more tension members being directly or indirectly coupled to said extension member; pressing the apparatus against a longitudinal side of the post such that the post is positioned within a space defined by first and second ends of the one or more tension members; and positioning the object on the extension member.

In one embodiment of the method, the extending member comprises a distal portion and a proximal portion, the proximal portion being positioned between the distal portion and the tension member. In this embodiment, the apparatus further comprises a support portion extending from the extending member distal portion, such that when the fence member is positioned within the space, the support portion extends towards said fence member.

In one embodiment of the method, the extending member comprises a hook to which the object may be positioned.

In one embodiment of the method, the apparatus comprises a ring adapted to be positioned around a circumference of the fence member when the fence member is positioned within the space.

In one embodiment of the method, the fence member is a generally vertical fence post.

In one embodiment of the method, the fence post is cylindrical.

In one embodiment of the method, the fence post is metallic.

In one embodiment of the method, the object is suspended from said extending member.

### BRIEF DESCRIPTION OF THE DRAWINGS

FIG. 1 is a side view of the hanging apparatus coupled to a post and a hanging basket in place in accordance with a preferred embodiment.

FIG. 2 is a side view of the hanging apparatus coupled to a post in accordance with a preferred embodiment.

FIG. 3 is a side view of the hanging apparatus coupled to a post in accordance with another embodiment.

FIG. 4a is a top view of one embodiment of the clamping member of the apparatus, wherein the clamping member is shown coupled to a post.

FIG. 4b is a top view of one embodiment of the clamping member of the apparatus.

FIG. 5 is a side view of the hanging apparatus coupled to a post in accordance with another embodiment.

FIG. 6 is a top view of another embodiment of the clamping member of the apparatus.

FIG. 7 is a side view of the hanging apparatus in accordance with another embodiment.

FIG. 8 is a side view of the hanging apparatus in accordance with another embodiment.

FIG. 9A is a top view of another embodiment of the clamping member of the apparatus.

FIG. 9B is a top view of another embodiment of the clamping member of the apparatus.

FIGS. 10, 11 and 12 are isometric views of another embodiment of the apparatus clamping member.

FIG. 13 is an isometric view of the latch assembly shown in an open position in accordance with a preferred embodiment.

FIG. 14 is an isometric view of the latch assembly shown in a closed position in accordance with a preferred embodiment.

FIG. 15A is a side view of the extending member of the apparatus in accordance with a preferred embodiment.

FIG. 15B is a top view of the extending member of 15.

FIG. 16 is a side view of the apparatus in accordance with another embodiment.

FIG. 17 is a side view of the clamping member in accordance with another preferred embodiment.

FIG. 18 is a side view of the clamping member in accordance with another embodiment.

FIG. 19 is a side view of the apparatus coupled to a post in accordance with another embodiment.

FIG. 20 is a side view of the apparatus coupled to a post in accordance with another embodiment.

### DESCRIPTION OF THE PREFERRED EMBODIMENT

A preferred embodiment of the device 14 is presented in the figures referenced above. In describing the embodiments of the invention, specific terminology will be used for the sake of clarity. However, the invention is not intended to be limited to the specific terms so selected, it being understood that each specific term includes all technical equivalents operating in a similar manner to accomplish a similar purpose. It is understood that the drawings are not drawn exactly to scale. In the drawings, similar reference numbers are used for designating similar elements throughout the several drawings.

This specification and appended claims describe particular embodiments of the invention. However, it should be understood, based on this disclosure, that the invention is not limited to the embodiments detailed herein. As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation. The detailed description illustrates by way of example, not by way of limitation, the principles of the invention. This description will clearly enable one skilled in the art to make and use the invention, and describes several embodiments, aspects, adaptations, variations, alternatives, and uses of the invention, including what is presently believed to be the best mode of carrying out the invention.

The examples and illustrations of a garden hanging apparatus are described herein with respect to mounting to and holding certain objects. However, the inventive system is equally applicable for use with other surfaces and for holding other objects. Moreover, while certain materials are discussed herein with respect to various components of the various embodiments, the embodiments are not limited to such materials. For example, in a preferred embodiment, certain components are formed from metal. However, as will be discussed in more detail below, the components of the device may comprise any suitable materials without departing from the scope and spirit of this disclosure.

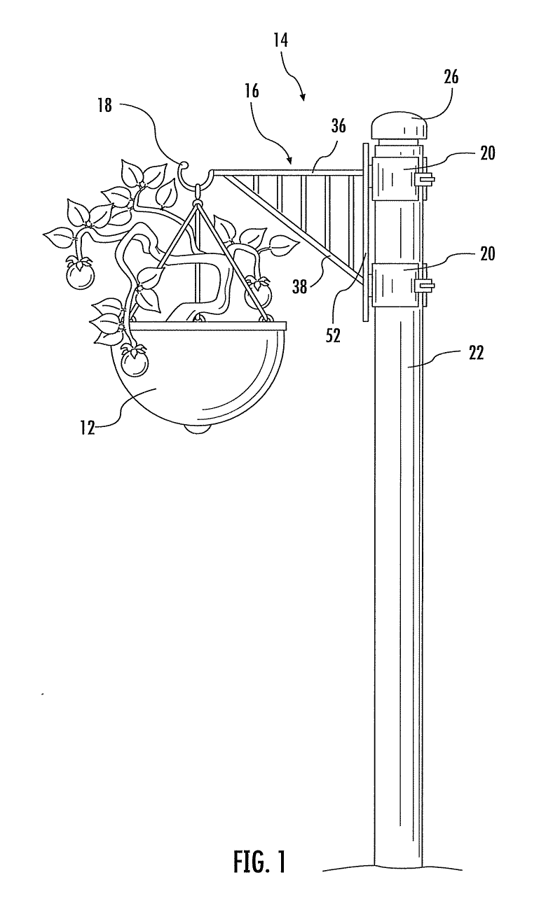

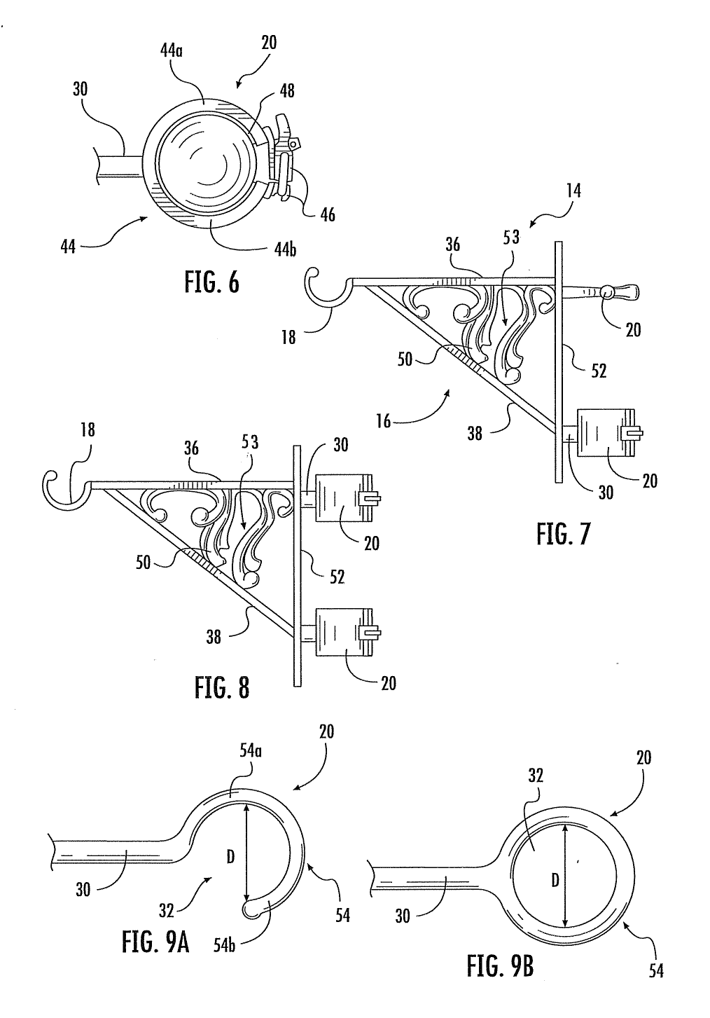

Referring to FIGS. 1-8, in a preferred embodiment of the present invention, the device 14 generally comprises one or more extending members 36, one or more brace members 38, and one or more clamping members 20. In a preferred embodiment such extending 36 and clamping members 20 are elements of a bracket 16. The bracket 16 of the preferred embodiment also comprises a hook member 18 and one or more clamp extension arms 30. The bracket 16 is generally right-triangular in shape and comprises an extending member 36, and brace member 38. Referring to FIGS. 7 and 8, in other embodiments, the bracket 16 further comprises a vertical member 52. In such embodiments, the brace member 38 spans between and is coupled to the extending 36 and vertical members 52. In the preferred embodiment, the extending member 36 is generally oriented above the brace member 38 and comprises a hook member 18 positioned near an intersection of the brace and extending members 38, 36. Such hook member 18 is suitable for suspending or hanging an object such as a hanging basket 12.

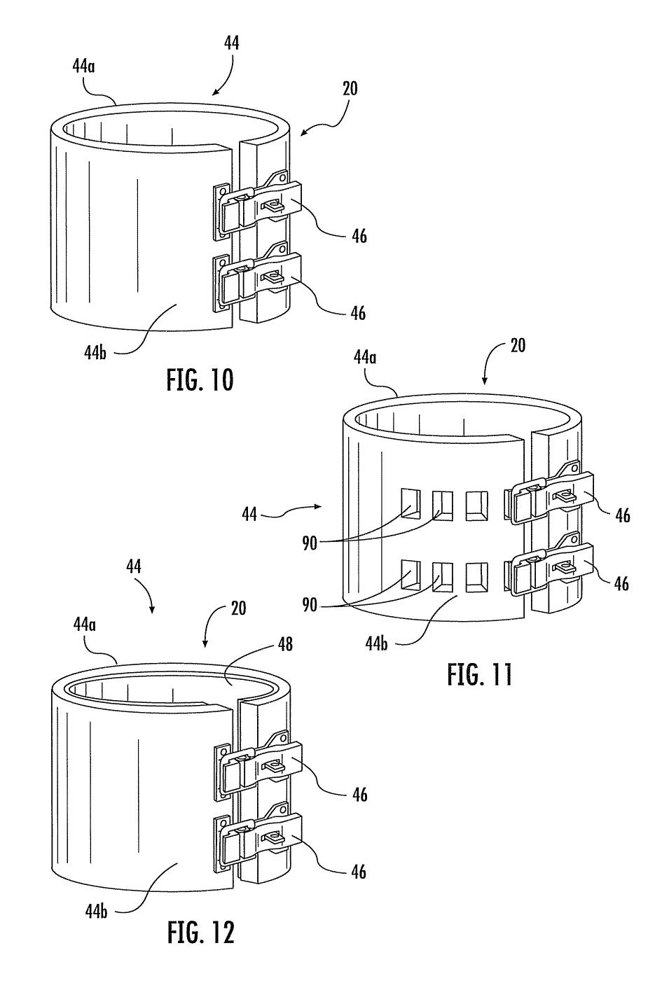

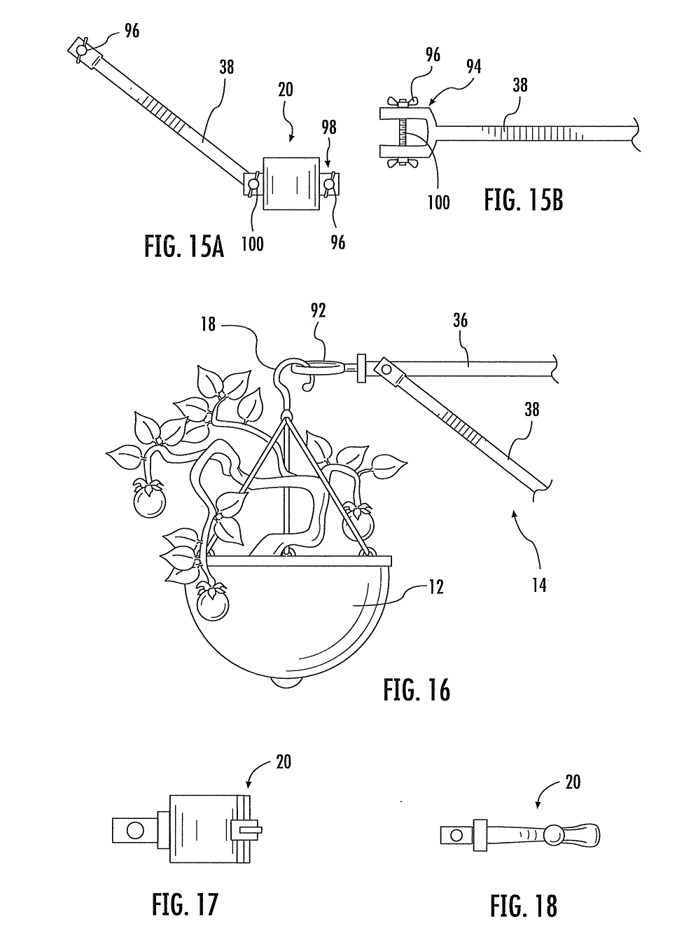

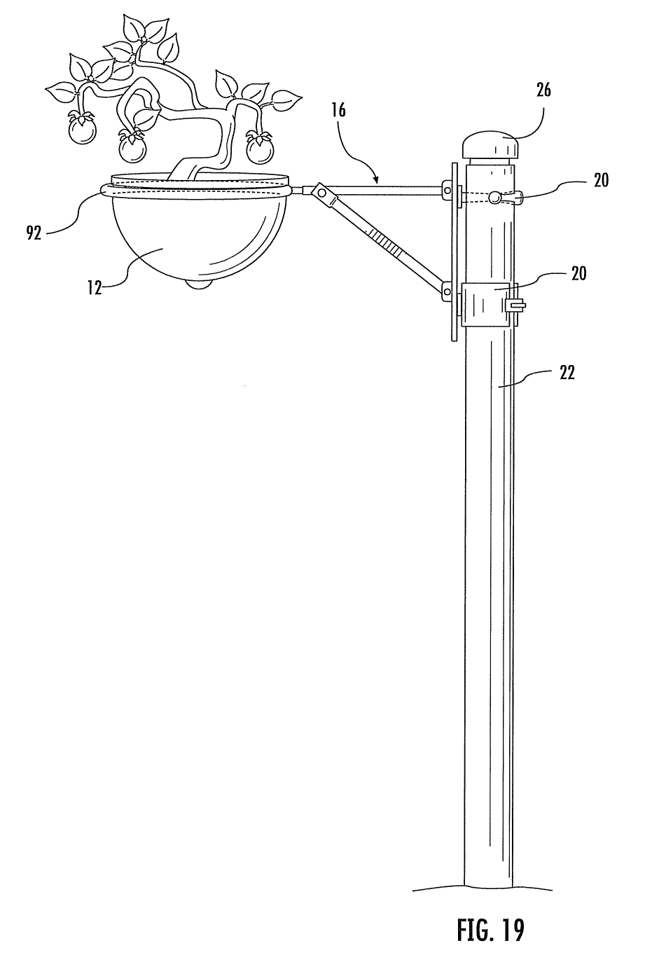

As shown in FIGS. 1, 2, 3, and 5, the apparatus 14 is structured and arranged such that it can easily be mounted to a fence post 22, or fence cross-member, and when so mounted, is capable of supporting an object 12 suspended from the hook 18 or other portion of the bracket 16 or an object positioned on top of or within the bracket 16. The bracket 16 is coupled to the post 22 by one or more of the clamping (tension) members 20. In preferred embodiments, these clamping members 20 may comprise a C-shaped spring/flexible tension assembly 34, as shown in FIGS. 4a and 4b, a C-shaped clamp/clasp assembly 54 as shown in FIG. 9, or a U-shaped spring/flexible tension assembly 44 as shown in FIGS. 10-12. Alternatively, referring to FIGS. 15A and 15B, the clamping members 20 may comprise one or more flanges 98. Such one or more flanges 98 may be used to secure the clamping member 20 to the post 22. In this embodiment, wing nuts 96 may be thumb threaded to a bolt 100 and against a flange 98 side to tighten the flange 98. In the embodiment shown in FIGS. 15A and 15B, the brace member 38 may comprise a prong-like opening 94 adapted to receive the extending member 36, as, for example, is shown in FIG. 16. The extending member 36 may be secured to the prong-line opening of the brace member 38 with a bolt 100 and wing nut 96 arrangement or some other suitable fastening arrangement.

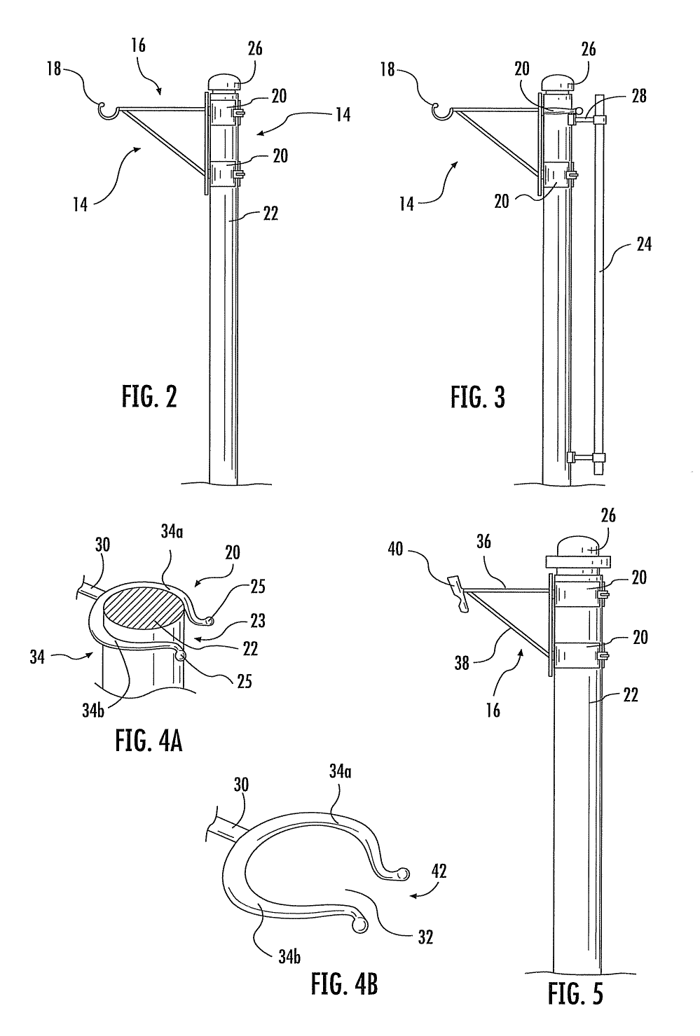

Referring to FIGS. 1, 2, & 6, in one embodiment, the apparatus 14 is secured to the post 22 with two clamping members 20. In this embodiment, a clamp extension arm 30 spans between an upper clamping member 20 and the extending member 36 such that the upper clamping member 20 is positioned approximately adjacent to the extending member 36 at the top of the bracket 16. At a lower end of the bracket 16 a lower clamping member 20 is coupled to the bracket 16 with a lower clamp extension arm 30 such that the lower clamping member 20 is positioned at a lower end of the brace member 38 at the bottom of the bracket 16.

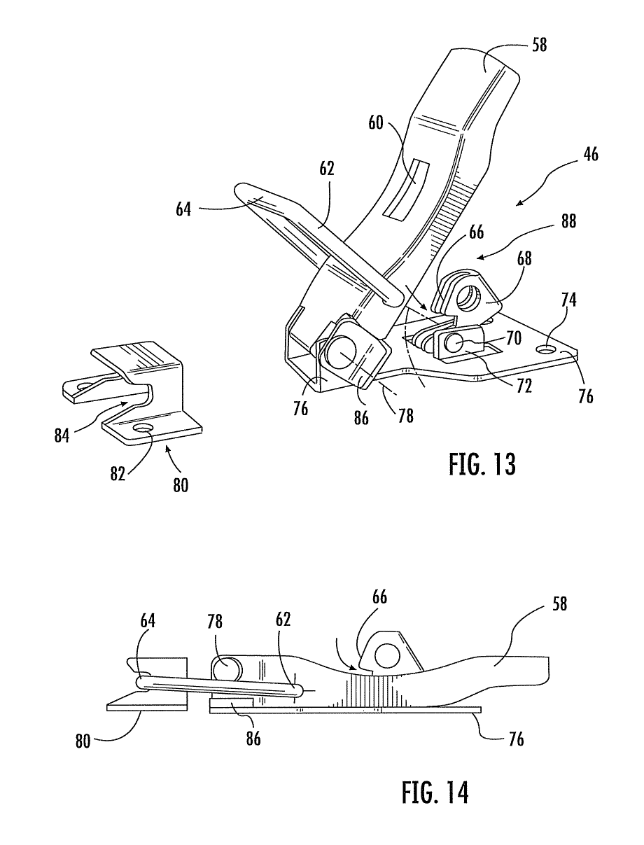

As shown in FIGS. 6, and 10-12, the clamping members 20 of this embodiment each comprise a U-shaped spring/flexible tension assembly 44. This assembly 44 comprises the extension arm 30 and collars 44a, 44b arranged such that the collars 44a, 44b may be positioned around the post 22. The collars 44a, 44b are structured such that the assembly 44 is flexible and elastic. Collars 40a, 40b have tension forces acting opposite of one another such that the assembly 44 rests in an open position. The collars 44a, 44b comprise padding 48 such that the assembly 44 will not abrade, scratch, or otherwise damage the post 22 when placed in position. Referring to FIGS. 13 and 14, the collars 44a, 44b may be closed about a post 22 by use of latch mechanism 46 so that the assembly 44 and apparatus 14 may be positioned on the post 22,

The latch mechanism 46 of the preferred embodiment comprises a main body 88 and a detent portion 80 which allow for cooperative coupling of the two portions 88, 80. The main body 88 comprises a lever 58 pivotally coupled by pin 78 to base 76. Pivotally coupled to the lever 58 is clasp 62 which is structured and arranged to be cooperatively coupled at clasp end 64 within detent slot 84 of the detent portion 80. Detent openings 82 permit the detent 80 to be mounted on collar 44b (FIGS. 10-12). Main body base 76 has base openings 74 that permit the main body 88 to be coupled to collar 44a (FIGS. 10-12). Side plate 86 pivots with lever 58 provide support for lever 58 when in a closed position (FIG. 14). Lever 58 has an opening 60 that is arranged to allow locking portion 68 to be inserted. Locking portion 68 is pivotally and elastically coupled to side mount 72 with pin 70. A front ridge 66 of locking portion 68 engages front portion of lever opening 60 to allow the latch 46 to be securely closed as shown in FIG. 14.

When in an open position, the latch 46 is coupled to one collar 44a. The latch 46 is arranged so that it may be coupled to the other collar 44b and drawn tight. Thus, the latch 46 spans from one collar 44a to the other 44b when in a closed position. Drawing the collars 44a, 44b tight when the assembly 44 is in the closed position brings the two collars 44a, 44b nearer to one another and snugly against the post 22. This latch 46 is adjustable so that it can be easily used on posts 22 of different diameters. For example, referring to FIG. 11, collar 44b may comprise openings 90 which allow detent 80 to be positioned in different openings 90 so as to allow the U-shaped, C-shaped, circular, or otherwise arcuate clamping assembly 44 to accommodate different sized posts 22. Thus, the latch mechanism 46 permits the clamping member 20 to be closed around the post 22 so that the device 14 may be easily attached to the post 22 without the use of tools.

Although the latch member 46 has been described above as comprising various elements, other suitable latch members 46 which allow the collars 44a, 44b to be drawn against post 22 may be used without departing from the scope and spirit of this disclosure.

Referring to FIG. 2, the upper clamping member 20, 44 is positioned beneath the metal fence post cap 26 and the lower clamping member 20, 44 placed generally in-line with the upper clamping member 20, 44 and around the post 22 in a lower position. With the clamping member 20, 44 placed in the secure closed position, the apparatus 14 will generally not twist or slide and will remain in a desired position on the post 22.

Referring to FIG. 3, there is shown another embodiment of the present invention, In this embodiment, one or more of the clamping members 20 comprise a C-shaped spring/flexible tension assembly 34, as shown in FIGS. 4a and 4b which secures the device 14 to the post 22 of a stockade fence 24. In this embodiment, assembly 34 comprises collars 34a, 34b arranged so as to be in tension towards each other 34a, 34b. The collars 34a, 34b form an opening 32 (FIG. 4b) between them 34a, 34b such that the assembly 34, when in a closed position as shown in FIG. 4a, generally conforms to the contours of the post 22. The tension aspect of the assembly 34 permits the collars 34a, 34b to compress against the post 22 when the assembly 34 is positioned around the post 22. Tapered opening 23 permits the assembly 34 to be easily pressed onto a post 22. Such action expands collars 34a, 34b to allow the post 22 to enter opening 23. As the assembly 34 is pressed further against post 22, collar ends 25 move off the post 22 allowing collars 34a, 34b to contract towards one another 34a, 34b and against the post 22. In this embodiment, the top clamping member 20 is placed just under the fence post cap 26 and immediately above the bracket 28 that attaches the post 22 to the stockade fence 24. The clamping members 20 may also comprise a U-shaped, C-shaped, circular, or otherwise arcuate spring/flexible tension assembly 44, as shown in FIGS. 10-12.

Referring to FIG. 7, the garden hanging apparatus 14 may comprise ornate features 50 in an inner right-angle portion 53 of the device 14. In this embodiment, the bracket 16 is generally right triangular in shape and comprises an extending member 36, a brace member 38 and a vertical member 52. The brace member 38 spans between and is coupled to the extending 36 and vertical members 52. The device 14 further comprises a U-shaped (FIG. 4A and 4B), C-shaped, circular (FIG. 9B), or otherwise arcuate fastener (FIG. 9A) assembly 54 adapted to be positioned beneath the metal fence post cap 26 and immediately above the fence bracket 28. In this embodiment the fastener assembly 54 extends from the extending member 36 such that it 54 may be placed around the fence post 22. In the embodiment shown in FIGS. 7 and 9A, the assembly comprises collars 54a, 54b that form fastener opening 32. This opening 32 has a diameter D that permits the assembly 54 to be placed around the post 22 but narrow enough to prevent the assembly 54 from sliding over the fence post cap 26. In the embodiment shown in FIG. 9B, the assembly 54 comprises circular collar 54 that defines fastener opening 32. This opening 32 has a diameter D that permits the assembly 54 to be placed around the post 22 and over the fence post cap 26. A circular tension or flex clamp/clasp assembly 44 as that shown in FIGS. 10-12 may also be used to attach the apparatus 14 to the metal fence post 22.

The bracket 16 of this embodiment further comprises ornate features 50. Such features 50 may comprise decorative material which may also provide additional structural support to the bracket 16. Referring to FIG. 8, in one embodiment the apparatus 14 with ornate features 50 may comprise U-shaped, C-shaped, circular, or otherwise arcuate clamps/clasps assemblies 44 with easy lock spring or tension features 46 to secure the device 14 to the metal fence posts 22.

Although in a preferred embodiment, the apparatus 14 comprises tension features 46, the apparatus 14 need not necessarily comprise such tension features 46. For example, as discussed above, one or more fastener assemblies 54 (FIGS. 9A and 9B for example) may couple extending member 36 or vertical member 52 to the fence post 22.

In another embodiment, and as shown in FIG. 5, the bracket 16 may comprise a flag holder 40 which may be used to display and secure flags, banners, and other objects comprising a shaft. In another embodiment, the bracket 16 may comprise a shelf upon which objects may be supported. In still other embodiments, the apparatus 14 may be combined with another apparatus 14 with an object or shelf spanning between the two devices 14.

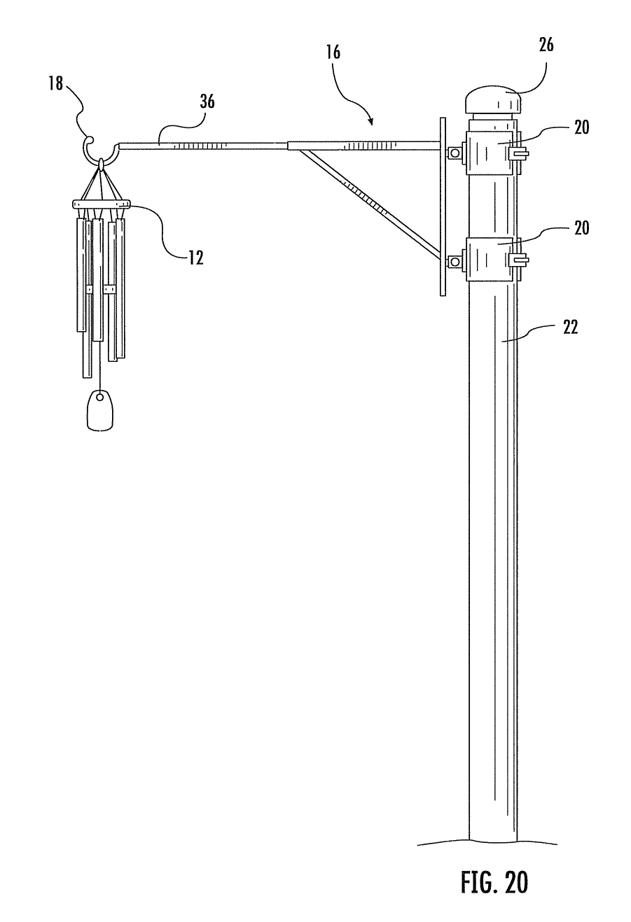

The apparatus 14 may be secured to larger diameter metal posts 22 as shown in FIG. 5. In such an embodiment, the garden hanging apparatus 14 may be attached to the post 22 by use of the cushioned and padded collar assembly 44 shown in FIG. 6. As shown, the collar assembly 44 comprises a flexible latch portion 46 that prevents abrasion of metal or wooden posts 22. Referring to FIG. 20, in one embodiment, the apparatus 14 comprises a retractable extension member 36. In this embodiment, the extension member 36 is telescopically arranged. As shown in FIG. 16, the extension member 36 may comprise an open portion 92 adapted to receive a hook 18 of a hanging object 12, or as shown in FIG. 8, the extension member 36 may comprise a hook 18 to receive a hook 18.

In the preferred embodiment, the garden hanging apparatus 14 is constructed from metal. However, the apparatus 14 need not be formed from metal. Rather, other materials such as polycarbonates, plastics, PVC, wood, and the like may be used. Additionally, the material may be formed from materials that are UV resistant. The apparatus 14 can be modified to present a wooden or rustic appearance, as well as other variations. Also, the apparatus 14 need not be limited to metal or cylindrical posts 22. Rather, the apparatus 14 is suitable for use with a variety of posts 22 formed in a variety of shapes and materials.

In a preferred embodiment of the method, the method of positioning an object 12 adjacent to a fence post 22, comprises the steps of providing a fence post 22; providing an apparatus 14 comprising one or more arcuate tension members 20 and an extension member 36, the one or more tension members 20 being directly or indirectly coupled to said extension member 36; pressing the apparatus 14 against a longitudinal side of the post 22 such that the post 22 is positioned within a opening 32 defined by first 34a and second ends 34b of the one or more tension members 20; and positioning the object 12 on the extension member 36.

In one embodiment the method, the extension member 36 comprises a distal portion and a proximal portion, the proximal portion being positioned between the distal portion and the tension member 20. In this embodiment, the apparatus 14 further comprises a support portion 38 extending from the extension member 36 distal portion, such that when the fence member 22 is positioned within the opening 32, the brace member 38 extends towards said fence member 22.

In one embodiment of the method, the extension member 36 comprises a hook 18 to which the object 12 may be positioned.

In one embodiment of the method, the apparatus 14 comprises a ring 20 adapted to be positioned around a circumference of the fence member 22 when the fence member 22 is positioned within the opening 32.

In one embodiment of the method, the fence member 22 is a generally vertical fence post 22.

In one embodiment of the method, the fence post 22 is cylindrical.

In one embodiment of the method, the fence post 22 is metallic.

In one embodiment of the method, the object 12 is suspended from said extension member 36.

The foregoing disclosure and showings made in the drawing are merely illustrative of the principles of this invention and are not to be interpreted in a limiting sense. While the invention is shown in only a few forms, it is not just limited to the forms shown, but is susceptible to various changes and modifications without departing from the spirit thereof. The foregoing description of a preferred embodiment of the invention has been presented for the purpose of illustration and description. It is not intended to be exhaustive or to limit the invention to the precise form disclosed. Obvious modifications or variations are possible in light of the above teachings. The invention may be adapted for use in a number of environments.

The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention in accordance with the breadth of this disclosure, to which it is fairly, legally, and equitably entitled to be interpreted.

I claim:

1. An apparatus adapted for coupling to a fence member, the apparatus comprising:
an extending member;
a tension member, the tension member comprising, first and second ends, and sides, said sides spanning between said first and second ends and defining a generally arcuate shape and a space;
the space being structured and arranged to receive the fence member;
a first portion of said sides being in tension towards a second portion of said sides such that the fence member is compressed when positioned within said space;
the extending member being coupled directly or indirectly to the tension member and extending in an outward direction in relation to the space;
and wherein said extending member is adapted to permit an object to be positioned thereon,

2. The apparatus of claim 1, the extending member comprising a distal portion and a proximal portion, said proximal portion being positioned between said distal portion and the tension member; the apparatus further comprising a support portion extending from said extending member distal portion, such that when the fence member is positioned within said space, said support portion extends towards said fence member.

3. The apparatus of claim 2, the extending member further comprising a hook to which said object may be positioned.

4. The apparatus of claim 1, further comprising a ring adapted to be positioned around a circumference of said fence member when said fence member is positioned within said space.

5. The apparatus of claim 1, wherein said fence member is a generally vertical fence post.

6. The apparatus of claim 5, wherein said fence post is cylindrical.

7. The apparatus of claim 6, wherein said fence post is metallic.

8. An apparatus adapted for coupling to a fence member, the apparatus comprising:
an extending member;
a support member;
at least first and second tension members, the tension members each comprising, first and second ends, and sides, said sides spanning between said respective first and second ends and defining a generally respective arcuate shape and a respective space;
each of said spaces being structured and arranged to receive the fence member;
a first portion of each of said sides being in tension towards a second portion of said respective sides such that the fence member is compressed when positioned within said space;
the extending member being coupled directly or indirectly to said first tension member and extending in an outward direction in relation to the space defined by the first tension member;
the extending member comprising a distal portion and a proximal portion, said proximal portion being positioned between said distal portion and the tension member;
the support portion being coupled, directly or indirectly to said second tension member;
and wherein said extending member is adapted to permit an object to be positioned thereto.

9. The apparatus of claim 8, the extending member further comprising a hook to which said object may be positioned.

10. The apparatus of claim 9, wherein said fence member is a generally vertical cylindrical fence post.

11. The apparatus of claim 10, wherein said apparatus comprises an ornate feature positioned between said extending member and said support member.

12. The apparatus of claim 10, wherein said one or more tension members comprise a rear clasp.

13. A method of positioning an object adjacent to a fence member, the method comprising the steps of:
providing a fence member;
providing an apparatus comprising one or more arcuate tension members and an extension member, said one or more tension members being directly or indirectly coupled to said extension member;
pressing said apparatus against a longitudinal side of said fence member such that said fence member is positioned within a space defined by first and second ends of said one or more tension members; and
positioning said object on said extension member.

14. The method of claim 13, the extension member comprising a distal portion and a proximal portion, said proximal portion being positioned between said distal portion and the tension member; the apparatus further comprising a support portion extending from said extension member distal portion, such that when the fence member is positioned within said space, said support portion extends towards said fence member.

15. The method of claim 14, the extension member further comprising a hook to which said object may be positioned.

16. The method of claim 15, further comprising a ring adapted to be positioned around a circumference of said fence member when said fence member is positioned within said space.

17. The method of claim 16, wherein said fence member is a generally vertical fence post.

18. The method of claim 17, wherein said fence post is cylindrical.

19. The method of claim 18, wherein said fence post is metallic.

20. The method of claim 13, wherein said object is suspended from said extension member.
